(19) United States
(12) Patent Application Publication
(10) Pub. No.: US 2006/0100100 A1
(43) Pub. Date: May 11, 2006

(54) Tetrahedrally-bonded oxide semiconductors for photoelectrochemical hydrogen production

(76) Inventors: Donald T. Morelli, White Lake, MI (US); Joseph Pierre Heremans, Troy, MI (US)

Correspondence Address: STEFAN V. CHMIELEWSKI;DELPHI TECHNOLOGIES, INC., Legal Staff, Mail Code: 480-410-202, P.O. Box 5052, Troy, MI, 48007-5052, US

(21) Appl. No.: 10/982,675

(22) Filed: Nov. 5, 2004

(51) Int. Cl. B01J 23/58

(52) U.S. Cl. 502/330; 502/343

(57) ABSTRACT

A photocatalyst for the decomposition of water is provided that includes a tetrahedrally-bonded oxide semiconductor having an energy band gap in the range of about 1.5 eV to 3.2 eV. A photoelectrochemical cell for hydrogen production and a method of producing a photocatalyst for the decomposition of water is also provided.

### BACKGROUND OF THE INVENTION

1. Field of the Invention

The present invention is directed to a photocatalyst for the decomposition of water and, more particularly, to a photocatalyst that includes a tetrahedrally-bonded oxide semiconductor. The photocatalyst of the present invention may be used in photoelectrochemical systems for the production of hydrogen.

2. Background of the Invention

Hydrogen gas is seen as a future energy carrier by virtue of the fact that it is renewable, does not evolve the “greenhouse gas” CO₂ in combustion, liberates large amounts of energy per unit weight in combustion, and is easily converted to electricity by fuel cells. Several advanced hydrogen production techniques, including hydrogen production from the pyrolysis of biomass, photobiological hydrogen production from algae and bacteria sources, and photoelectochemical (PEC) hydrogen production by the dissociation of water using solar energy, are currently being studied to determine their feasibility for the large-scale production of hydrogen. It is the latter technique that is the subject of this invention.

In its simplest form, a photoelectrochemical (“PEC”) cell consists of two electrodes immersed in an aqueous electrolyte and connected electrically by a wire. One of these electrodes is a metal that does not react chemically with the electrolyte; the other electrode is a semiconductor with one face in contact with the electrolyte and the other face connected to the shorting wire by an ohmic contact. Ideally, when light falls on the semiconductor electrode, oxygen gas is liberated at one electrode and hydrogen is liberated at the other.

The operation of a PEC cell may generally be explained in terms of electron energy levels in the electrodes and the electrolyte. For an n-type semiconductor photoanode, light incident upon the semiconductor with energy (hv) greater than the energy gap of the material (E_{g}), results in the generation of an electron-hole pair. This pair is separated by the electric field in the depletion region. Under the influence of this electric field the electrons move away from the surface of the semiconductor and then transfer via a circuit to the metal counter-electrode where they discharge H₂ according to the reaction:
2H⁺+2e⁻→H₂↑ (Cathode).

The holes, on the other hand, move to the semiconductor-electrolyte interface and discharge O₂ according to the oxidation reaction:
OH⁻+2p→½O₂↑+H⁺ (Photoanode).

For p-type semiconducting photoanodes, a hole depletion region is formed with the photogenerated electrons moving to the semiconductor-electrolyte interface and the holes transferred via the external circuit to the metal counter-electrode. Accordingly, hydrogen is liberated at the semiconductor electrode and oxygen at the metal counter-electrode.

For direct photoelectrochemical decomposition of water to occur, several key criteria of the semiconductor must be met: (1) the semiconductor's band gap must be sufficiently large to dissociate water and yet not too large as to prevent efficient absorption of the solar spectrum (the ideal range is 1.8-2.4 eV); (2) the band edges of the semiconductor must overlap the hydrogen and oxygen redox potentials; (3) the semiconductor material must be stable in aqueous solution; and (4) the semiconductor material must be relatively low cost. Most of the recently studied semiconductors for use in PEC cells have failed to meet all of these criteria. Titanium dioxide (TiO₂), one of the most commonly used materials for making photoanodes in PEC cells, is stable in water, but with a band gap of about 3.3 eV, is a poor absorber of solar photons (see, e.g., FIG. 3). To overcome these limitations, a large effort has been devoted to transition-metal doping of TiO₂ and, even more recently, carbon substitution for oxygen in TiO₂. While these methods have been shown to increase the hydrogen production efficiency of a PEC cell, the resulting materials are generally unstable in long-term water exposure.

In addition to TiO₂, other semiconductors considered for use in PEC cells include AL_{1·x}GaₓAs, GaP, CdSe, CdS, SiC, SnO₂, ZnO, WO₃, and Fe₂O₃. Fe₂O₃, for example, exhibits a suitable band gap and is relatively inexpensive, but its electrical conductivity is inadequate. Unfortunately, ZnO and SnO₂ have a large band gap (e.g., at least 3.2 eV). Like TiO₂, WO₃ based materials have electronic properties dominated by oxygen vacancies. A partial disordering of the TiO₂ crystal structure, for instance, leads to the emergence of oxygen vacancies and interstitial metal ions. In the course of prolonged electrochemistry, the metal ions are oxidized while the oxygen vacancies are filled with oxygen, the surface layer of the semiconductor becomes insulating and the photocatalytic effect decays.

For at least these reasons, there exists a need for improved semiconductors for use in PEC cells that are chemically stable, inexpensive and exhibit an energy gap as close as possible to the dissociation energy of water into hydrogen and oxygen.

### SUMMARY OF THE INVENTION

The present invention includes, among other things, a photocatalyst for the decomposition of water. In an embodiment, the photocatalyst includes a tetrahedrally-bonded oxide semiconductor having an energy band gap in the range of about 1.25 eV to 3.2 eV. In another embodiment, a tetrahedrally-bonded compound is provided according to the formula [A][B]O₂, wherein [A] is Cu, Ag, Au or a metal ion that can achieve a 1⁺ charge state and [B] is Ga, In, Al, Cr, Fe, Co, Rh, Sc, Y, a lanthanide ion or a metal ion that can achieve a 3⁺ charge state. The photocatalyst of the present invention is particularly useful in photoelectrochemical cells for hydrogen production. A method of producing a photocatalyst for the decomposition of water is also provided.

### BRIEF DESCRIPTION OF THE DRAWINGS

Embodiments of the invention will now be described, by way of example, with reference to the accompanying drawings, wherein:

FIG. 1 is a schematic diagram of a photoelectrochemical cell according to an embodiment of the present invention;

FIG. 2 is a graphical illustration of solar irradiance as a function of photon energy; and

FIG. 3 is a graphical illustration of the amount of solar power in energies above a given photon energy.

### DETAILED DESCRIPTION

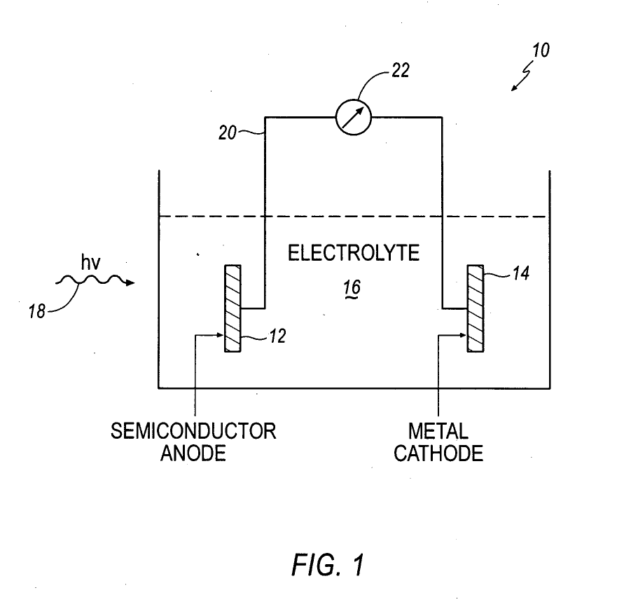

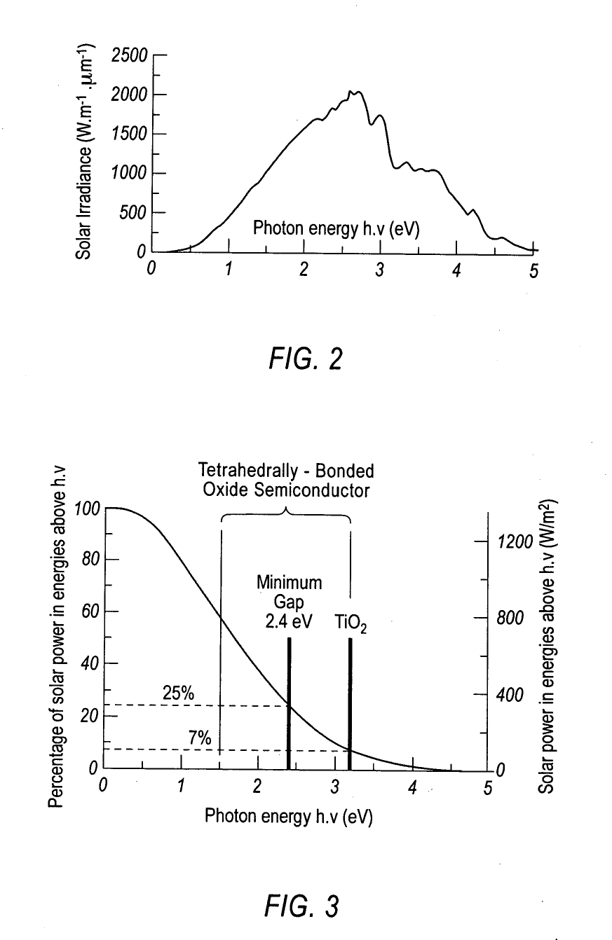

Referring to FIG. 1, there is schematically shown a photoelectrochemical cell 10 having a semiconductor electrode (anode) 12, which includes a semiconductor material according to an embodiment of the present invention, and a metal counter-electrode (cathode) 14. Electrodes 12 and 14 are separated by an electrolyte 16, such as an aqueous solution. Incoming electromagnetic radiation, for example, sunlight, is shown by an arrow 18. The electrodes 12, 14 are connected by an external circuit 20 to a load, which is illustrated in FIG. 1 as a meter 22. Ideally, when light falls on semiconductor electrode 12, oxygen gas is liberated at one electrode and hydrogen is liberated at the other.

As noted above, the operation of photoelectrochemical cell 10 may be generally explained in terms of electron energy levels in the electrodes 12, 14 and electrolyte 16. For p-type semiconducting photoanodes, such as Titanium dioxide (TiO₂) for example, a hole depletion region is formed with the photogenerated electrons moving to the semiconductor-electrolyte interface and the holes are transferred via the external circuit 22 to the metal counter-electrode. Accordingly, hydrogen is liberated at the semiconductor electrode and oxygen at the metal counter-electrode.

As noted above, attempts to decrease the band gap of TiO₂ by alloying the semiconductor with other transitional metal elements has resulted in materials that are unstable in long term water exposure. This phenomenon is caused by the presence of oxygen vacancies in these materials, as evidenced by the prevalent p-type conduction mechanism. A similar stability phenomenon is observed in the oxide semiconductor WO₃, which has a suitable energy gap of 2.6 eV, but whose electronic properties are highly dependent on oxygen vacancy concentration.

Oxygen vacancies in oxide semiconductors are much more likely to occur in structures in which the metal ion is octahedrally-coordinated by oxygen. On the other hand, structures in which the metal ion exhibits a tetrahedral structure have few oxygen vacancies, since it is more energetically favorable to remove an oxygen vacancy from a metal ion that is octahedrally-coordinated. For example, zinc oxide (ZnO), a tetrahedrally-coordinated semiconductor, is extremely stable against oxygen vacancies and, as a result, is highly stable in aqueous solution (provided the water is saturated with zinc ions). Unfortunately, however, ZnO exhibits a band gap that is too large (i.e., 3.2 eV) for efficient PEC hydrogen production.

To overcome the limitation of ZnO, the present invention provides a family of oxide semiconductor materials that are based on the tetrahedrally-coordinated ZnO structure, but exhibit band gaps smaller than ZnO itself. The resulting oxide semiconductors may be used as a photocatalyst for decomposition of water into hydrogen and oxygen, such as in a semiconductor electrode (anode) of a PEC cell.

In an embodiment, the tetrahedrally-coordinated semiconductor materials of the present invention are produced by first doubling a zincblende structural unit (e.g., ZnO) in a first direction to create a pseudo-Zn₂O₂-like structure. Next, the two column IIB zinc ions, each of which contribute two electrons to the bonding orbitals of the ZnO complex, are replaced with one column IB ion (e.g., Cu, which contributes one electron) and one column IIIB ion (e.g., Ga, which contributes three electrons). The total electron number contributed from the cation site is therefore constant at four. The resulting is a delafossite structure (in the preceding example the delafossite structure is CuGaO₂), which is a tetrahedrally-bonded semiconductor compound.

The tetrahedrally-bonded, or at least partially tetrahedrally-bonded compound according to the present invention may be represented by the formula [A][B]O₂, wherein:
[A] is Cu, Ag, Au or any other metal ion that can achieve a 1⁺ charge state; and
[B] is Ga, In, Al, Cr, Fe, Co, Rh, Sc, Y, a lanthanide ion or any other metal ion that can achieve a 3⁺ charge state.

As, illustrated in FIG. 3, the resulting tetrahedrally-bonded compounds exhibit band gaps in the range of about 1.5 eV to 3.2 eV. For example, the delafossite compound CuAlO₂ exhibits a band gap of about 1.97 eV, which is within the above-noted ideal range of 1.8-2.4 eV. Moreover, the semiconductor compounds of the present invention are highly stable in aqueous solution due to their tetrahedral bonding arrangement. As will be appreciated, the combination of a relatively low band gap and high stability in aqueous solution make the tetrahedrally-bonded semiconductor compounds of the present invention particularly useful as catalysts in the decomposition of water and, accordingly, in photoelectrochemical cells for hydrogen production.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A photocatalyst for the decomposition of water; comprising:
a tetrahedrally-bonded oxide semiconductor having an energy band gap in the range of about 1.5 eV to 3.2 eV.

2. The photocatalyst of claim 1, wherein the oxide semiconductor is partially tetrahedrally-bonded.

3. A photocatalyst for the decomposition of water; comprising:
a tetrahedrally-bonded compound according to the formula [A][B]O₂, wherein:
[A] is Cu, Ag, Au or a metal ion that can achieve a 1⁺ charge state; and
[B] is Ga, In, Al, Cr, Fe, Co, Rh, Sc, Y, a lanthanide ion or a metal ion that can achieve a 3⁺ charge state.

4. The photocatalyst of claim 3, wherein the tetrahedrally-bonded compound includes an energy band gap in the range of about 1.5 eV to 3.2 eV.

5. The photocatalyst of claim 3, wherein the tetrahedrally-bonded compound is partially tetrahedrally-bonded.

6. A photoelectrochemical cell for hydrogen production, comprising:
a tetrahedrally-bonded oxide semiconductor having an energy band gap in the range of about 1.5 eV to 3.2 eV.

7. The photoelectrochemical cell of claim 6, wherein the oxide semiconductor is partially tetrahedrally-bonded.

8. A photoelectrochemical cell for hydrogen production, comprising:
a tetrahedrally-bonded compound according to the formula [A] [B]O₂, wherein:
[A] is Cu, Ag, Au or a metal ion that can achieve a 1⁺ charge state; and
[B] is Ga, In, Al, Cr, Fe, Co, Rh, Sc, Y, a lanthanide ion or a metal ion that can achieve a 3⁺ charge state.

9. The photoelectrochemical cell of claim 8, wherein the tetrahedrally-bonded compound includes an energy band gap in the range of about 1.5 eV to 3.2 eV.

10. The photoelectrochemical cell of claim 8, wherein the tetrahedrally-bonded compound is partially tetrahedrally-bonded.

11. A method of producing a photocatalyst for the decomposition of water, the method comprising the steps of:
providing a zincblende structure unit cell;
doubling the zincblende structure unit cell in one direction; and
replacing two column IIB zinc ions with one column IIB ion and one column IIIB ion to form a tetrahedrally-bonded semiconductor structure compound, or replacing two column IIB zinc ions with a metal ion that can achieve a 1⁺ charge state and a metal ion that can achieve a 3⁺ charge state to form a tetrahedrally-bonded semiconductor structure compound.

12. The method of claim 11, wherein the step of providing a zincblende structure further includes providing a zinc oxide structure.
